(19) United States
(12) Patent Application Publication
(10) Pub. No.: US 2006/0091570 A1
(43) Pub. Date: May 4, 2006

(54) Apparatus to better distribute an insect repellent or fragrance

(76) Inventor: Crale Reece, Townsville (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/523,973

(22) PCT Filed: Aug. 5, 2003
(86) PCT No.: PCT/AU03/00986

§ 371 Date: Feb. 8, 2005

(51) Int. Cl. A01M 13/00

(52) U.S. Cl. 261/19; 239/44; 43/125

(57) ABSTRACT

A fan containing apparatus (10) has a first enclosure (13) which can accommodate a coventional mosquito coil/mosquito candle/vaporising device, etc. The smoke/vapours are blown by the fan through an outlet in the apparatus to provide a much better distribution of the gas/smoke/vapour into a room. A perforated hose (21) can be attached to the outlet to provide a much better positioning of the gas/smoke/vapour in a room or outdoor area.

### FIELD OF THE INVENTION

This invention is directed to an apparatus (typically in the form of a small box) which can better distribute the smoke from a mosquito coil/candle etc or which can better distribute the vapour from a vaporiser. In a broad form, the invention is directed to a fan containing apparatus which can better distribute any type of beneficial vapour/smoke/gas etc. The beneficial action may comprise an insect repellent, a fragrance, a deodorizing agent and the like.

### BACKGROUND ART

A very common way to deter or repel mosquitoes and biting insects is to place a mosquito coil or a mosquito candle in the area where the deterrent effect is required. The smoke from the mosquito coil and the vapour from the mosquito candle provides a deterrent to biting insects. A disadvantage with these coils and candles is that the effective deterrent area is not very large. If the mosquito coil or candle is placed in a closed room, it is found that the greatest deterrent occurs above the coil or candle as the smoke/vapours tend to move upwardly. Conversely, if the mosquito coil or candle is placed outside, a breeze will tend to blow the smoke/vapour away from the deterrent area.

With mosquitoes, it is noticed that mosquitoes tend to congregate in certain areas. In a room, it is noticed that mosquitoes tend to congregate about the corners of the room. However, the smoke from the mosquito coil or the vapour from a mosquito candle does not effectively extend into this area.

Many types of vaporising devices are known. One common type of vaporising device is electrically operated and can be plugged into a power socket. The device contains a small reservoir of liquid repellent/fragrance/deodorizing agent etc and contains a small heating device which heats the liquid or a proportion of liquid. Again, a disadvantage with this device is that the treatment area is not very large. To properly deodorise an entire room, or to provide a repelling action in an entire room, it takes a long time before the vapours/smoke extend throughout the room.

It will be clearly understood that, if a prior art publication is referred to herein, this reference does not constitute an admission that the publication forms part of the common general knowledge in the art in Australia or in any other country.

### OBJECT OF THE INVENTION

The present invention is directed to a simple yet extremely useful device or apparatus which can assist in dispersing the smoke from a mosquito coil, the vapour from a mosquito candle, the vapour from a vaporiser etc in a more efficient manner.

It is an object of the invention to provide an apparatus which may overcome at least some of the above-mentioned disadvantages and/or provide the public with a useful or commercial choice.

In one form, the invention resides in an apparatus to dispense a beneficial gas/smoke/vapour, the apparatus having an enclosure, the enclosure adapted to contain a gas/smoke/vapour generating device, a fan to pass air at least partially through the enclosure and to entrain at least some of the gas/smoke/vapour, an outlet through which the gas/smoke/vapour can pass.

The term “beneficial gas/smoke vapour” includes the smoke from a mosquito coil, vapours from a vapourising device such as a candle, an electrically operated vapouriser, and other devices that generate a smoke/gas/vapour that repels, kills or otherwise deters insects, moths and other undesirable creatures.

It is preferred that an elongate tube is provided, and that the tube has at least one opening which is operatively associated with the outlet such that gas/smoke/vapour passing through the outlet passes at least partially through the tube. The tube may have a length of between 1-10 m or even more, and may have a diameter of between 5-50 mm or even more. The tube may be perforated at least partially along its length and therefore make comprise a perforated ducting. Preferably, the tube is perforated along its length which allows the smoke/gas/vapour to pass out of the perforations. The tube may comprise a tube having sections which are not perforated and sections which are perforated. The smoke/gas/vapour will pass along the non perforated section of the tube and through the openings in the perforated section of the tube. This allows the tube to be laid in such a manner that the smoke/gas/vapour only passes into a desired area. This can be achieved, if necessary, by providing separate tubes which can be fitted together with one tube not been perforated and another tube being perforated. This concept can be extended to include tube lengths having different types, sizes and numbers of perforations to control the volume of smoke/gas/vapour passing out of the tube at any particular place.

The tube, or perforated ducting, can be made of any suitable material which may include plastics. The tube is preferably sufficiently flexible to allow it to be placed in desired areas.

The tube may have closeable openings to provide versatility to the device. This can be in the form of a collar which is slideable over the tube and which can close off some openings. Valves, taps and the like can also be present to direct the smoke to desired parts of the tube.

The tube may be substantially circular if desired although this is not necessary. Alternatively, the tube may be rectangular, oval, or have other shapes. It is considered that the tube may have a discreet or “low-profile” and this can be achieved by giving the tube a flattened oval shape, or giving the tube a rectangular shape having a low-profile.

The tube may be positioned along the ground to enable the smoke etc to be directed into a suitable region. In one form, the tube may be simply laid along the ground. However, the tube may also be suspended from a wall, post, or anchored to the ground or otherwise placed in position. Thus, the invention may also comprise fasteners, attachment, clips, or other types of accessories to enable the tube to be placed in a desired position. These fasteners etc may be separate and the tube may be attached to the fasteners; alternatively, the fasteners make comprise part of the tube or may be otherwise attached to the tube.

Suitably, the fan passes air from outside the enclosure and into the enclosure. In this manner, the smoke laden air does not pass through the fan. However, in another form, the fan may form part of a fan enclosure which has an inlet and an outlet, the inlet of the fan enclosure being in communication with the enclosure, and the outlet of the fan enclosure being in communication with the outside of the apparatus. In this version of the invention, the smoke laden air does pass through the fan.

In another form, the invention resides in an apparatus, the apparatus having a first enclosure adapted to contain a mosquito coil/candle/vaporising device, an inlet to allow air to pass into the first enclosure, a fan enclosure which has an inlet and an outlet, a fan, the inlet of the fan enclosure being in communication with the first enclosure, and the outlet of the fan enclosure being in communication with the outside of the apparatus.

Thus, in accordance with the invention, a commercially available mosquito coil or mosquito candle can be lit and placed in the enclosure. The fan can then be started which will blow the smoke containing air more vigorously into a room/outside area etc. There is no need to provide a complicated system to produce the smoke/vapour as the apparatus allows a conventional mosquito coil, mosquito candle etc to be used.

In an extremely broad form, the invention can comprise an apparatus having a single enclosure in which the mosquito coil etc can be placed. A fan can blow air through the enclosure and through an outlet to direct smoke laden air to a desired area. The fan can be placed in the enclosure, next to the enclosure etc. The fan can be reversed such that the air can be sucked through the enclosure from the outlet and through the inlet. Other changes and modifications are envisaged.

The apparatus is typically box shaped in configuration and small enough to be placed on the ground, on a shelf, on a stand etc. However, there is no need for the apparatus to be box shaped and other types of shapes are envisaged. However, the apparatus will typically have a top wall, a bottom wall, a rear-wall, sidewalls and a front wall. The enclosure should be large enough to accommodate the mosquito coil etc which is to be placed in the enclosure. The size of this can vary to suit.

The enclosure typically has an air inlet to allow air to pass into the enclosure. The air inlet may comprise a series of perforations in one or more walls of the enclosure, although other arrangements are envisaged.

The enclosure is typically provided with some form of door/flap or other type of access means to allow the mosquito coil etc to be placed into the first enclosure. Typically, a side wall of the apparatus is hinged to provide a door. It is preferred that one side wall is hinged by a top horizontal hinge which means that the door will naturally fall to a closed position. This allows the apparatus to be simple in design.

It is preferred that the air inlet comprises one or more apertures in the door. Thus, the door can be seen as a vented door. However, the air inlet may be another part of the apparatus. For instance, if the fan draws air from the outside of the enclosure, the air inlet may comprise the inlet of the fan.

It is preferred that the enclosure is made of heat resistant material. This minimises any chance of damage to the first enclosure by virtue of a mosquito candle, a lit mosquito coil etc.

In one embodiment of the invention, the apparatus may comprise a pressurised unit. In this version, the fan may have an inlet communicating with the outside of the enclosure, and an outlet communicating with the inside of the enclosure. Thus, air is blown into the inside of the enclosure causing a degree of pressurisation. The enclosure may comprise an outlet through which the pressurised air can pass. The outlet may be attached to or otherwise in communication with a perforated ducting as described above. Suitably, the mosquito coil/candle/vaporising device etc is positioned in the enclosure.

In another embodiment of the invention, the apparatus is provided with a venturi. The venturi may comprise a tube in the enclosure. One end of the tube is associated with the fan outlet such that pressurised air blows from the fan outlet and into the venturi. The other end of the venturi can be associated with the outlet. As the air blows into the venturi, it provides a region of low-pressure which sucks in adjacent air. The adjacent air comprises the smoke/gas/vapour laden air in the enclosure. An advantage of this arrangement is that smoke does not pass through the fan.

The apparatus may have a fan enclosure. The fan enclosure typically comprises a shroud about a fan, the shroud having an inlet and an outlet. Other types of arrangements are envisaged however it is preferred that the design of the fan and fan enclosure is such that there is little mixing of incoming air and exiting air as the function of the fan is to blow the smoke/vapour laden air out of the apparatus. The fan enclosure may be formed in a second enclosure of the apparatus. The second enclosure may be separated from the first enclosure and this can be achieved using a partition wall and the like. This arrangement can prevent damage to the fan. The inlet of the fan enclosure may be in communication with the first enclosure. Typically, the fan enclosure is attached to one wall of the first enclosure, and an opening is provided in the wall to allow air to pass into the inlet of the fan enclosure. If desired, a screen, filter etc may be provided. The outlet of the fan enclosure can communicate with the outside of the apparatus. In a simple form the outlet may communicate with or be part of a tube, conduit, or other type of enclosure which funnels the air passing through the outlet towards an outlet in the apparatus.

The outlet in the apparatus may comprise a valve or other type of opening. The advantage of this arrangement is that a flexible hose can be attached to the outlet. The hose may be perforated and blocked at the end to force the mosquito coil smoke etc to pass through the perforations in the hose. The hose may be several metres long and may be placed wherever necessary in a room or an outdoor area to provide a much greater repellent action than would be possible with a single mosquito coil or even a number of mosquito coils. Thus, one advantage of the apparatus is that a single mosquito coil/mosquito candle can be as effective in a larger area which previously would require a large number of candles/coils etc. Moreover, by using the flexible hose the repellent smoke/vapour etc can be channelled to precisely where needed.

Alternatively, the apparatus may be provided with a second enclosure/third enclosure and like which may be provided with an open top, an elongate slot etc to allow smoke/vapour to pass from the apparatus. While this arrangement does not contain a flexible hose, it will still disperse the smoke/vapour more efficiently.

The fan may be electrically powered. In one form of the invention, the fan may be powered by a battery. In another form of the invention, the fan may be powered by a rechargeable battery and the battery can be recharged from a power source using conventional techniques. In another form, the fan may be powered from a vehicle cigarette lighter socket, or mains power. It is envisaged that the fan may also be solar powered. It is envisaged that the fan may be a variable speed fan and some form of control knob etc can be provided to adjust the rotational speed of the fan. The fan may be controlled by an on/off switch or by any other suitable means.

The apparatus need not be limited to use with a mosquito coil, mosquito candle, an oil or any other product which is lit or burnt to provide the repellent action. For instance, the apparatus is sufficiently versatile to enable it to be used with a vaporising device. A typical well-known vaporising device plugs into a power socket. Therefore, the apparatus may be provided with a power socket in the first enclosure to enable a conventional vaporising device to be simply plugged into the socket in the first enclosure.

### BRIEF DESCRIPTION OF THE DRAWINGS

Embodiments of the invention will be described with reference to the following drawings in which:

FIG. 1. Illustrates an apparatus for use with a mosquito coil/mosquito candle etc.

FIG. 2. Illustrates an apparatus for use with a plug in vaporiser.

FIG. 3. Illustrates a further embodiment of the apparatus in the form of a pressurised unit.

FIG. 4. Illustrates a further embodiment of the apparatus containing a venturi.

### BEST MODE

Referring to the drawings and initially to FIG. 1 there is illustrated an apparatus 10 which can better disperse a repellent/fragrance/deodorising composition etc in a particular area. The apparatus 10 is substantially box like and can have a length of between 20-60 cm, a width of between 10-40 cm and a height of between 10-30 cm. These dimensions can of course vary to suit. The apparatus can be made of any suitable material but it is preferred that the material is substantially waterproof (to allow the apparatus to be used outdoors) and fireproof (to allow a mosquito candle etc. to be placed in the apparatus). Thus, the material may comprise metal, fibre cement and the like.

The apparatus has a top wall, a bottom wall, a rear wall, a pair of closed sidewalls, and a front wall, these walls being substantially continuous and attached to form a substantially enclosed container. However, the front wall comprises a door 11. Door 11 is hinged at the top by a horizontal hinge 12 which allows the door to naturally fall into a closed position allowing the door to have a very simple yet effective design. However, the door can also be hinged by a bottom hinge, a side hinge, can be a sliding door, a clip on door or any other type of door.

The door forms one side of a first enclosure 13. The first enclosure 13 is large enough to hold a mosquito coil/mosquito candle or any other device which is to be placed within the first enclosure. The first enclosure is defined by part of the top wall, part of the bottom wall, and part of each side wall as well as the door 11. In the particular embodiment, the rear wall does not form part of the first enclosure. Door 11 is provided with an array of vent openings 14 to allow air to pass into the first enclosure. While this is a simple arrangement, the invention is not to be limited to this particular type of air inlet to the first enclosure.

The first enclosure 13 is also defined by an intermediate partition wall 15. Wall 15 is provided with an opening which forms part of the inlet to the fan enclosure 16. The partition wall 15 is spaced from rear wall 17 to form a second area 18 which is separated from the first enclosure 13.

The second area 18 contains the fan enclosure 16. The fan enclosure 16 is a cylindrical shroud which passes about the fan. The enclosure 16 has a fan inlet which extends into the first enclosure 13, and a fan outlet which comprises a tapering tube 19 which tapers to an outlet 20 passing through a side wall of the container. The outlet 20 allows a flexible perforated hose 21 to be attached to the outlet. The hose 21 can have any suitable length and diameter and allows the exhaust from the fan (containing the mosquito smoke etc) to be dispersed to any suitable area simply by positioning the perforated hose in that area. This provides a real and substantial advantage over other devices.

The fan can be powered either by a 12 volt power source (typically a vehicle cigarette lighter) or by a transformer to transform mains power into a lower voltage. In the embodiment, a power socket 22 is provided on one side wall into which the cigarette lighter attachment can plug or into which the transformer can plug, providing versatility to the apparatus.

When camping, the apparatus can be placed next to a campsite and can be powered by the cigarette lighter attachment in a vehicle. The flexible hose 21 can be positioned around the area which is to be protected. In a house, the apparatus can be placed on the ground or anywhere else and the flexible hose can be placed against the wall of the room as an extremely efficient and effective deterrent. It is also found that use of the fan provides better burning of a mosquito coil by providing a continual draft of air to assist in the burning action. This again adds to the efficiency of the apparatus.

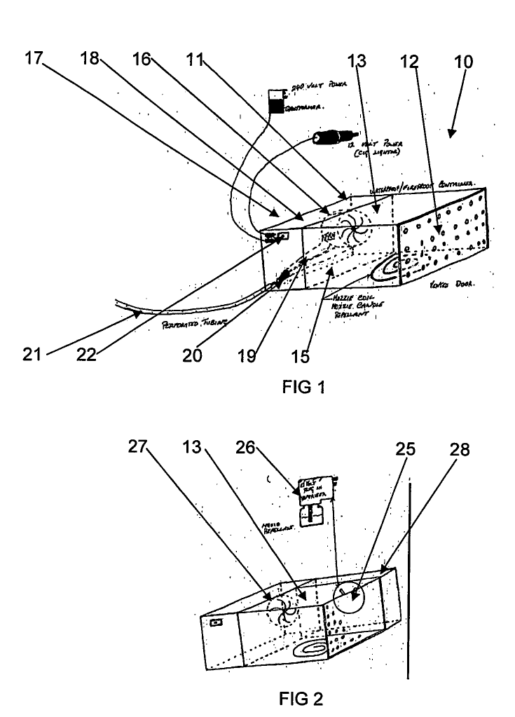

Referring to FIG. 2, there is described an apparatus which is similar to the apparatus of FIG. 1 except that one wall of the first enclosure 13 is provided with a socket 25 to enable a plug in vaporiser 26 to be simply plugged into the socket 25 inside enclosure 13. A fan 27 can then be operated to suck air through the first enclosure in a manner similar to that described above. In this arrangement and other compartment 28 is provided. This compartment can contain the rear portion of socket 25 and can be electrically insulated from the remainder of the container.

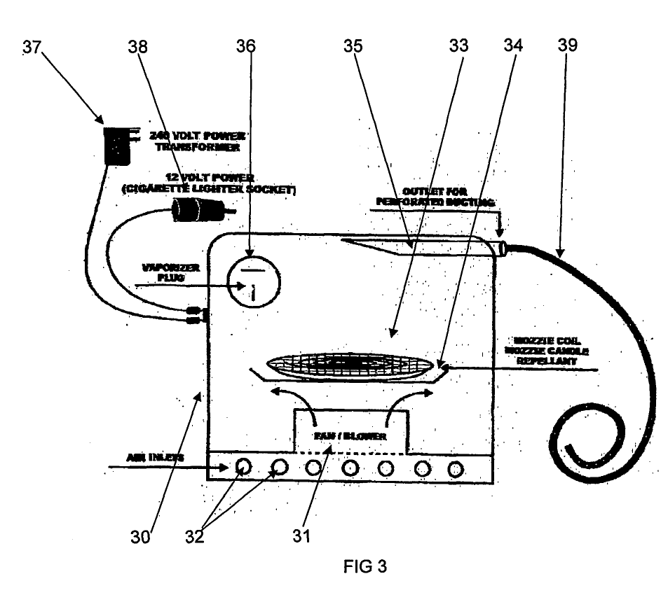

Referring to FIG. 3, there is illustrated a pressurised unit. One advantage of this unit is that the smoke laden air does not pass through the fan. The unit comprises a box like housing 30. At the bottom of the housing is a fan 31. The fan 31 draws air into housing 30 through a number of air inlet openings 32. The openings 32 communicate with the outside of housing 30. A mosquito coil/candle/repellent 33 is positioned above fan 31. This material is placed in a tray 34. The tray is made of solid material and is positioned above fan 31. As the fan blows air against the bottom of tray 34, the air passes around the sides of the tray and towards outlet 35. During this process, the smoke from the mosquito coil etc will be mixed with the air such that smoke laden air will pass through outlet 35. Tray 34 prevents the coil etc from burning to quickly by preventing air from blowing directly against the coil. The unit can also contain a vaporising device (not illustrated) which can be plugged into plug 36 and this can be connected to a source of electrical power in a manner already described above which may include mains power via a transformer 37 or battery power via a cigarette lighter socket 38. Of course, other types of power sources are envisaged such as solar power etc. The outlet 35 communicates with the perforated ducting 39 already described above which allows the smoke laden air to be dispensed in any desirable place.

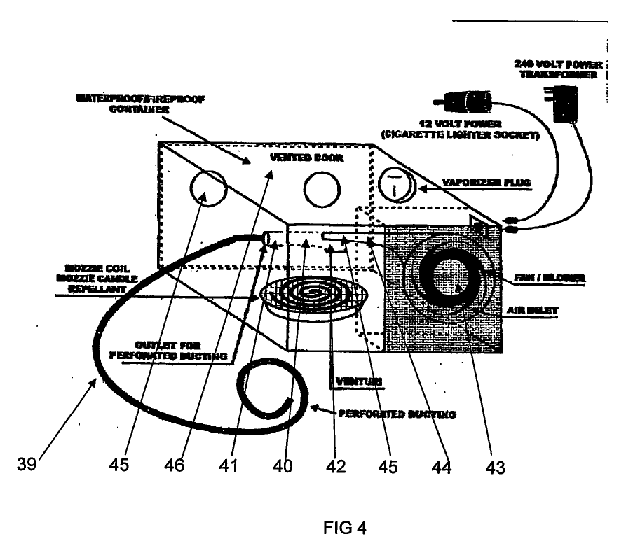

FIG. 4 illustrates another variation which again has the benefit of preventing smoke laden air passing through the fan. This variation can be seen as the “venturi variation”. In this variation, a venturi pipe 40 is provided, one end of which forms the outlet 41. The perforated ducting 39 is connected to outlet 41 in a manner similar to that described above. The other end of the venturi has a flared opening 42. The fan 43 draws air in from the outside of the unit and through a fan housing 44 which has a nozzle like outlet 45 which blows pressurised air into the flared opening 42. By doing so, an area of low-pressure is created which sucks adjacent air through venturi 40. The adjacent air is the smoke/vapour laden air inside the unit. The unit contains the mosquito coil/candle or a vaporising device similar to that described above. An advantage of this arrangement is that the unit is not pressurised. Further inlet openings 45 are provided in the vented door 46 to replace air which passes through the venturi by virtue of the “venturi effect”.

It should be appreciated that various other changes and modifications can be made to any embodiment described without departing from the spirit and scope of the invention.

1. An apparatus having an enclosure and a flexible hose extending from the enclosure, the enclosure adapted to contain a mosquito coil/candle/vaporising device, an inlet to allow air to pass into the enclosure, an outlet to allow air to pass out of the enclosure, and a fan to pass the air from the inlet and through the outlet, the air at least partially entraining smoke/gas/vapours emitted from the device, the outlet being in fluid communication with the hose to enable the smoke/gas/vapours to pass through the hose and to a position remote from the enclosure, the hose having at least one outlet through which the smoke/gas/vapours can pass.

2. The apparatus of claim 1, wherein the hose has a length of several meters.

3. The apparatus of claim 2, wherein the hose has a multiplicity of perforations which comprise the at least one outlet.

4. The apparatus as claimed in claim 1, wherein the enclosure is provided with a door.

5. The apparatus as claimed in claim 1 wherein the inlet comprises at least one opening in the door.

6. The apparatus as claimed in claim 1, comprising a shroud extending about the fan.

7. The apparatus as claimed in claim 1, comprising a second enclosure which is separate from the enclosure, the second enclosure containing the fan.

8. The apparatus as claimed in claim 1, comprising a second enclosure, the fan having fan enclosure provided with an inlet, inlet to the fan enclosure comprising an opening in a partition which separates the second enclosure from the enclosure.

9. The apparatus as claimed in claim 8, wherein the partition comprises a dividing wall.

10. The apparatus as claimed in claim 8, wherein the outlet of the fan enclosure comprises a tapering enclosed portion which tapers towards an outlet in a wall of the apparatus.

11. The apparatus as claimed in claim 1, wherein the fan has an intake area and an outlet area, the intake area being adjacent the inlet to prevent smoke laden air from passing through the fan.

12. The apparatus as claimed in claim 1, wherein a wall of the apparatus is provided with a power socket to allow an electrical power supply to power the fan.

13. The apparatus as claimed in claim 1, wherein the enclosure is provided with a power socket to allow a plug in vaporiser to plug into the power socket.

14. The apparatus as claimed in claim 1, wherein a mosquito coil is placed in the enclosure.

15. The apparatus as claimed in claim 1, wherein a mosquito candle is placed in the enclosure.

16. The apparatus as claimed in claim 1, wherein a deodorising agent is placed in the enclosure.

17. The apparatus as claimed in claim 1, wherein a fragrance emitting agent is placed in the enclosure.

18. The apparatus as claimed in claim 1 wherein the outlet is associated with a venturi.

19. The apparatus of claim 8 teams wherein the fan is in a housing, the housing having an outlet, the outlet passing pressurised air into one end of the venturi.
